(19) United States
(12) Patent Application Publication
(10) Pub. No.: US 2006/0191744 A1
(43) Pub. Date: Aug. 31, 2006

(54) Ladder offset attachment

(76) Inventor: Gerald M. Keller, Richmond, VA (US)

Correspondence Address: Gerald M. Keller, 9940 S. Wagstaff Circle, Richmond, VA, 23236, US

(21) Appl. No.: 11/356,480

(22) Filed: Feb. 17, 2006

Related U.S. Application Data
(60) Provisional application No. 60/656,140, filed on Feb. 25, 2005.

(51) Int. Cl. E06C 7/42

(52) U.S. Cl. 182/107

(57) ABSTRACT

An offset attachment for a ladder serves to space the upper portion of the ladder from a vertical supporting surface. The attachment comprises the following elements: 1) a first portion of metal sheeting of sufficient length to span at least two adjacent upper rungs of said ladder, 2) a horizontal support surface, and 3) a vertical contact surface for contact with said vertical supporting surface. The attachment is constructed from a single continuous selected length of metal sheeting by bending the metal sheeting at a first axis perpendicular to its length at an angle of 105-115° between element 1) and element 2) and by bending the metal sheeting at a second axis perpendicular to its length at an angle of about 90° between element 2) and element 3). The offset attachment of the invention may additionally comprise element 4) an angled contact surface adjacent the vertical contact surface element 3), which is formed by bending the metal sheeting at a third axis perpendicular to its length at an angle of 130 to 145° between element 3) and element 4). The method of economically manufacturing the ladder attachment from a single sheet of metal is also a part of the invention. The offset attachment is a simple device that can be economically manufactured and can be easily and securely attached to the ladder and be used in a safe manner.

Benefit is hereby claimed for Provisional Application for Patent No. 60/656,140 filed Feb. 25, 2005.

### BACKGROUND OF THE INVENTION

The invention relates to a ladder offset attachment that can be securely attached to the upper rungs of a ladder such as an aluminum or fiberglass extension ladder and serve to offset the top of the ladder away from the vertical surface against which the ladder rests or to extend the ladder above the edge of an overhanging roof while bridging the eaves and gutter. The attachment also provides an elevated surface for resting a window assembly or wall panel prior to installation as well as a convenient surface for placing desired tools. The simple structure and economical cost and ease of manufacture are important aspects of the invention.

### SUMMARY OF THE INVENTION

An offset attachment for a ladder serves to space the upper portion of the ladder from a vertical supporting surface. The attachment comprises the following elements: 1) a first portion of metal sheeting of sufficient length to span at least two adjacent upper rungs of said ladder, 2) a horizontal support surface, and 3) a vertical contact surface for contact with said vertical supporting surface. The attachment is constructed from a single continuous selected length of metal sheeting by bending the metal sheeting at a first axis perpendicular to its length at an angle of 105-115° between element 1) and element 2) and by bending the metal sheeting at a second axis perpendicular to its length at an angle of about 90° between element 2) and element 3). The offset attachment of the invention may additionally comprise element 4) an angled contact surface adjacent the vertical contact surface element 3), which is formed by bending the metal sheeting at a third axis perpendicular to its length at an angle of 130 to 145° between element 3) and element 4).

The method of economically manufacturing the ladder attachment from a single sheet of metal is also a part of the invention. The offset attachment is a simple device that can be economically manufactured and can be easily and securely attached to the ladder and be used in a safe manner.

### BRIEF DESCRIPTION OF THE DRAWINGS

FIG. 1 shows a rectangular sheet (1) of metal of selected size. The dotted lines A-A′, B-B′, and C-C′ represent the intended axes for bending the sheet into the desired form. The area D within the dotted lines can be cut out if desired to provide additional access to the supporting surface.

FIG. 2 shows a side edge view of the sheet after the bending operations are completed. A, B, and C are angles that correspond to the bending axes shown in FIG. 1.

FIG. 3 shows a cutaway view of means of attaching the attachment to the top rungs of a ladder using nut and bolt assembly units.

FIG. 4 shows a side elevation view of a ladder with the offset attachment supporting the ladder top away from a vertical wall.

FIG. 5 shows a side elevation view of a ladder with the offset attachment supporting the ladder top over and away from a gutter and eaves by using the roof as a support base

FIG. 6 is an isometric view of the top portion of the ladder with offset attachment of FIG. 4 leaning against a vertical supporting structure.

### DESCRIPTION OF THE PREFERRED EMBODIMENT

An offset attachment for a ladder that serves to space the upper portion of the ladder from a vertical supporting surface comprises the following elements:
1) a first portion of metal sheeting of sufficient length to span at least two adjacent upper rungs of said ladder;
2) a horizontal support surface; and
3) a vertical contact surface for contact with said vertical supporting surface.
   An important aspect of the invention, for ease and economy of manufacture said attachment is constructed from a single continuous selected length of metal sheeting. It may be preferred that the offset attachment additionally comprise element 4), an angled contact surface adjacent to and immediately below the vertical contact surface and formed from the same single continuous selected length of metal sheeting as elements 1), 2) and 3).

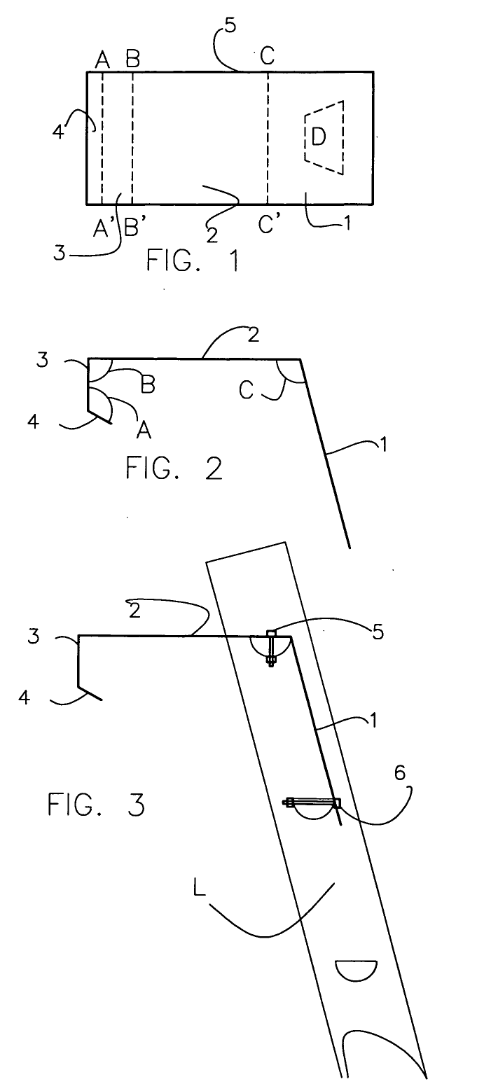

The metal sheet material for manufacture of the offset attachment can be selected from available metal sheet stock, including aluminum, steel, stainless steel, and galvanized sheet metal. We have found ⅛ inch rolled aluminum stock to offer sufficient strength, rigidity, and durability for this application. With reference to the drawings, FIG. 1 shows a rectangular metal sheet 5 of selected size. The dotted lines A-A′, B-B′, and C-C′ represent the intended axes, perpendicular to the length of the sheet, for bending the sheet into the desired form. The area D within the dotted lines can be cut out if desired to provide additional access to the supporting surface when placed in use. The width of the sheet may be selected to fit within the interior width between the side rails of the ladder to enable a close fit between the side rails such as can be seen in FIG. 6. In the U. S. aluminum and fiberglass extension ladders may have an interior width between the upper rails of, for example, from 13 to 14 inches. The length is selected to include sufficient length to form the elements 1), 2), and 3), and also 4), if desired. The attachment is manufactured by bending the sheet 1, utilizing known bending processes, at the intended bending axes A-A′, B-B′ and C-C′ to obtain the side edge view of the sheet shown in FIG. 2. In FIGS. 1 and 2 elements 1), 2), 3), and 4) are designated 1, 2, 3, and 4, respectively. Angles A, B and C correspond to the bending axes A-A′, B-B′, and C-C′, respectively. FIG. 5 shows a side elevation view of a ladder with the offset attachment supporting the ladder top over and away from a gutter and eaves by using the roof as a support base

Bending is accomplished by known methods. Angles for the bends can be chosen for specific purposes and applications. An angle of about 90° at angle B in FIG. 2 and 105-115° at C provides a horizontal surface (2) between angles B and C when the ladder is placed at the 76° angle recommended by the Occupational Safety and Health Agency (OSHA). The angle A in FIG. 2 can be chosen to accommodate the roof pitch when, as in FIG. 5, the top of the ladder is over and away from a gutter and eaves and uses the roof as a support base. A 130-145° angle A, for example 135° provides good contact with various roof pitches.

By bending the metal sheeting at a first axis (C-C′) perpendicular to its length at an angle of 105° to 115° between element 1) and element 2) and by bending the metal sheeting at a second axis (B-B″) perpendicular to its length at an angle of about 90° between element 2) and element 3), elements 1), 2) and 3) are produced from a single continuous selected length of metal sheeting. A preferred embodiment would also include element 4), the angled contact surface adjacent to and immediately below the vertical contact surface and formed from the same single continuous selected length of metal sheeting as elements 1), 2) and 3), which is accomplished by bending the metal sheeting at a third axis (A-A′) perpendicular to its length at an angle of 130° to 145° between element 3) and element 4).

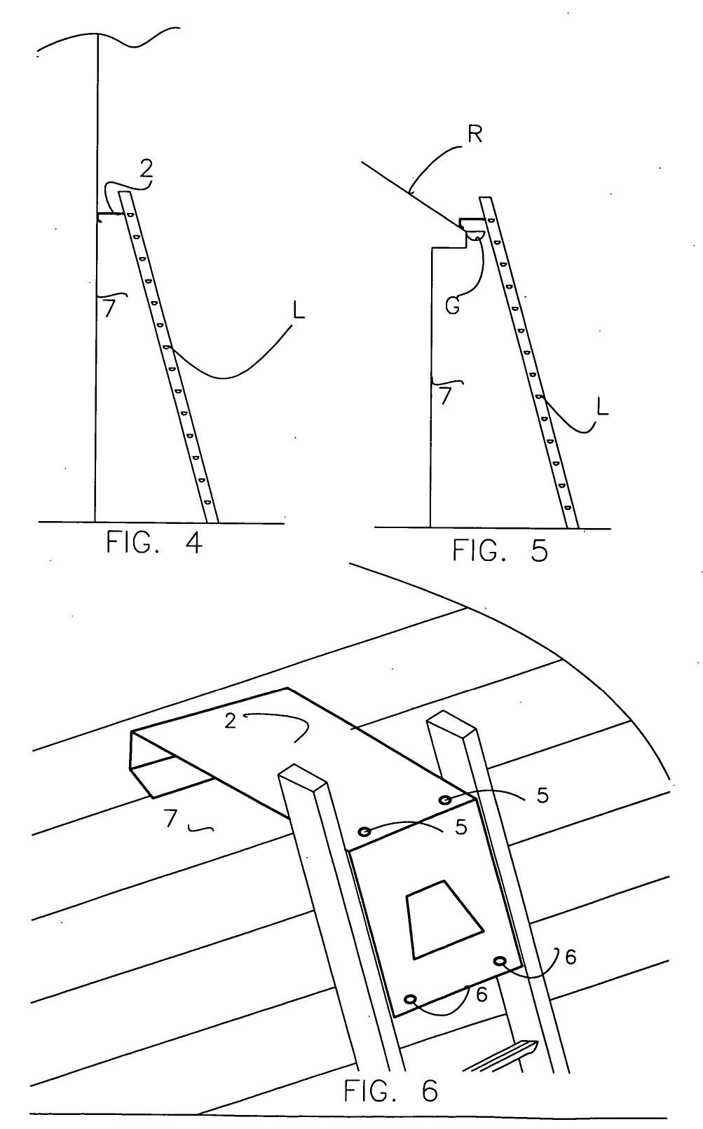

FIG. 4 shows a ladder L with the ladder attachment of the invention maintaining the upper end of the ladder away from the vertical supporting surface 7. Here the horizontal support surface 2 enables a worker to rest a wall panel or window assembly unit at the top of the ladder just below an elevated opening before its installation, or can serve as a rest for tools or other items needed by the workman. It may be desirable to cut a few holes in the horizontal surface (2) to serve as receptacles for various tools. A 2 inch hole will accommodate the handle of a hammer. Smaller holes, for example 0.5 or 0.75 inches, will accommodate a screwdriver or the handles of pliers. The user may easily drill such holes in the horizontal support surface (2) to suit his particular needs.

FIG. 5 shows a side elevation view of a ladder with the offset attachment supporting the ladder top over and away from a gutter G and eaves by using the roof R as a support base.

The offset attachment can be securely attached to the ladder by bolts through the ladder rungs as shown in FIG. 3 and FIG. 6. With reference to FIG. 3, holes sized to receive bolts may be drilled down through the horizontal support surface (2) and the upper ladder rung to insert bolt 5, and horizontally through the lower portion of element 1 (1) and the adjacent rung below the upper rung to insert bolt 6. The bolts (0.25×2.5 inch, for example) can be tightened securely. As shown in FIG. 6, four bolts enable a secure attachment. A singled centered bolt at each rung may be sufficient.

For greatest effectiveness and safety, the attachment should be attached to the top rungs of the ladder. If it is desired not to drill holes through the rungs, U-bolts sized to fit over the ladder rungs can be utilized, or clamps which would permit easily attaching and removing the attachment when desired. The attachment must be securely attached to the ladder before it can be safely used.

Stability is an essential consideration in safe use of a ladder. We have found that the resulting attachment of this invention, when secured to the top rungs of an extension ladder, provides good stability. If desired, a wider sheet can be chosen to provide a correspondingly wider contact area with the vertical supporting surface (i.e. the side of the structure against which the ladder leans). Thus the metal sheet 5 in FIG. 1 can be selected such that the width of the portion of metal sheeting to become element 1 and the portion of element 2 that will be mounted within the side rails of the ladder may be selected to fit within the interior width between the side rails of the ladder, and the width of the portion of metal sheet to become the portion of element 2 that extends beyond the side rails of the ladder after attachment and the portion of metal sheet to become element 3 and 4 can be greater than the interior width between the side rails. For example, this greater width can be chosen to match the exterior width of the ladder or greater. This greater width could also provide a sufficient amount of sheet metal that could be folded at right angles along the two side edges of the horizontal support surface to add additional strength and rigidity to the horizontal support surface.

If additional stability or greater contact area is desired a bar of metal or wood of appropriate length can be attached to the vertical contact surface for contact with said vertical supporting surface. A piece of carpet or foam can be readily attached to the vertical contact surface and the angled contact surface of the offset attachment using an adhesive material such as glue, tape or silicone caulking or screws to provide additional protection from marring the supporting surface. Material attached to the contact surfaces can also be selected to provide additional protection from slipping.

What is claimed is:

1. An offset attachment for a ladder that serves to space the upper portion of the ladder from a vertical supporting surface, said attachment comprising the following elements: a first portion of metal sheeting of sufficient length to span at least two adjacent rungs of said ladder; a horizontal support surface immediately adjacent said first portion; and a vertical contact surface for contact with said vertical supporting surface, said vertical contact surface immediately adjacent said horizontal support surface; wherein said attachment is constructed from a single continuous selected length of metal sheeting by bending the metal sheeting at a first axis perpendicular to its length at an angle of 100° to 115° between said first portion and surface and by bending the metal sheeting at a second axis perpendicular to its length at an angle of about 90° between said horizontal support surface and said vertical contact surface.

2. The offset attachment of claim 1 additionally comprising an angled contact surface immediately adjacent said vertical contact surface, said angled contact surface having been formed by bending the metal sheeting at a third axis perpendicular to its length at an angle of 130° to 145° between said vertical contact surface and said angled contact surface.

3. The offset attachment of claim 1 comprising attachment means for attaching said horizontal support surface to a first rung of the ladder and for attaching said first portion to a second rung adjacent to and below the first rung.

4. The offset attachment of claim 2 comprising attachment means for attaching said horizontal support surface to a first rung of the ladder and for attaching said first portion to a second rung adjacent to and below the first rung.
